(19) United States
(12) Patent Application Publication
(10) Pub. No.: US 2016/0149961 A1
(43) Pub. Date: May 26, 2016

(54) ADAPTIVE VOICE COMMUNICATION SYSTEM AND METHOD BASED ON HYPERTEXT TRANSPORT PROTOCOL

(71) Applicant: ELECTRONICS AND TELECOMMUNICATIONS RESEARCH INSTITUTE, Daejeon (KR)

(72) Inventor: Ik Soon KIM, Daejeon (KR)

(21) Appl. No.: 14/952,623

(22) Filed: Nov. 25, 2015

(30) Foreign Application Priority Data
Nov. 25, 2014 (KR) 10-2014-0165187
Nov. 18, 2015 (KR) 10-2015-0161793

(51) Int. Cl. H04L 29/06; H04L 29/08

(52) U.S. Cl. CPC H04L 65/1069; H04L 67/02; H04L 65/607; H04L 65/605

(57) ABSTRACT

A system and method of performing voice communication over a hypertext transport protocol (HTTP)-based network. The adaptive voice communication system includes a web server configured to issue a session identifier (ID), a talk transmission uniform resource locator (URL), and a talk reception URL and transmit an HTTP response in response to an HTTP request and a web client configured to transmit the HTTP request and transmit or receive voice information by using the issued talk transmission URL and talk reception URL.

### CROSS-REFERENCE TO RELATED APPLICATIONS

This application claims priority under 35 U.S.C. §119 to Korean Patent Application No. 10-2014-0165187, filed on Nov. 25, 2014, and Korean Patent Application No. 10-2015-0161793, filed on Nov. 18, 2015, the disclosure of which is incorporated herein by reference, in its entirety.

### BACKGROUND OF THE INVENTION

1. Field of the Invention

The present invention relates to a system and method of performing voice communication over a hypertext transport protocol (HTTP)-based network.

2. Description of Related Art

A voice over network protocol (VOIP) that is a voice transmission scheme has advanced by developing a separate dedicated protocol for efficiency of voice transmission. However, despite that the VOIP has a number of good characteristics, the development cost is high, and call quality is not adaptively changed in consideration of a network state. Also, a connection between networks is not easily made, and it is difficult to pass through a firewall. It is required to solve the above-described problems.

### SUMMARY

Accordingly, the present invention provides a system and a method, which enable a caller to talk with the other party at the highest voice quality over an HTTP-based network in consideration of a network state.

The present invention also provides a system and a method, in which the cost of establishing a voice communication system is reduced, and voice call quality is enhanced.

In one general aspect, an adaptive voice communication system based on hypertext transport protocol (HTTP) includes: a web server configured to issue a session identifier (ID), a talk transmission uniform resource locator (URL), and a talk reception URL and transmit an HTTP response in response to an HTTP request; and a web client configured to transmit the HTTP request and transmit or receive voice information by using the issued talk transmission URL and talk reception URL.

In another general aspect, an adaptive voice communication method based on hypertext transport protocol (HTTP) includes: (a) issuing a session identifier (ID), a talk transmission uniform resource locator (URL), and a talk reception URL and starting a call connection; (b) transmitting voice information through the talk transmission URL by using an HTTP POST method; (c) receiving the voice information through the talk reception URL by using an HTTP GET method; and checking information about whether to perform the call.

Other features and aspects will be apparent from the following detailed description, the drawings, and the claims.

### BRIEF DESCRIPTION OF THE DRAWINGS

FIG. 1 is a block diagram illustrating an adaptive voice communication system based on HTTP according to an embodiment of the present invention.

FIG. 2 is a flowchart illustrating an adaptive voice communication method based on HTTP according to an embodiment of the present invention.

### DETAILED DESCRIPTION OF EMBODIMENTS

The advantages, features and aspects of the present invention will become apparent from the, following description of the embodiments with reference to the accompanying drawings, which is set forth hereinafter.

The present invention may, however, be embodied in different forms and should not be construed as limited to the embodiments set forth herein. Rather, these embodiments are provided so that this disclosure will be thorough and complete, and will fully convey the scope of the present invention to those skilled in the art.

The terms used herein are for the purpose of describing particular embodiments only and are not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Before describing exemplary embodiments of the present invention, in order to help those skilled in the art understand the present invention, the background of the present invention will be first described.

A VOIP may be referred to as an Internet phone or a voice packet network and may be technology for realizing voice communication with packet data, based on an Internet protocol (IP) network.

A voice service which is provided over a public switched telephone network (PSTN) may be provided by using Internet protocol technology, and thus, enhanced services such as Internet fax and unified messaging in addition to telephone are provided.

The VOIP may be a service that provides various additional services and is good in click-to-call of a customer using the Web, but has the following problems: distortion of voice quality occurs; compatibility of a protocol is bad, and the development cost is high.

Multimedia streaming technology is undergoing a number of changes recently, and multimedia transmission technology uses a separately developed transmission protocol for efficiency of transmission. However, it is difficult to pass through a firewall, or transmission compatibility between networks is bad. For this reason, it is difficult to spread the use of the multimedia stream technology and the multimedia transmission technology.

A multimedia transmission protocol based on HTTP may be an adaptive streaming scheme, and in comparison with the related art dedicated protocol proposed for multimedia transmission, the development time and cost are reduced, and a problem, where it is difficult to pass through a firewall and transmission compatibility between networks is bad, is solved. Also, a performance of the multimedia transmission protocol based on HTTP is good.

The present invention relates to bidirectional transmission technology that enables both parties to perform voice communication, instead of unidirectional streaming technology such as the multimedia streaming technology. In particular, the present invention relates to an adaptive voice transmission technology based on

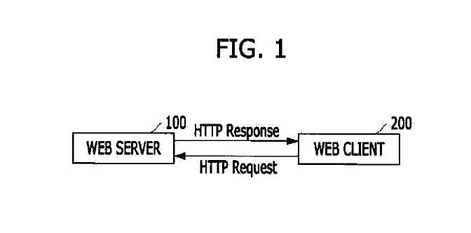

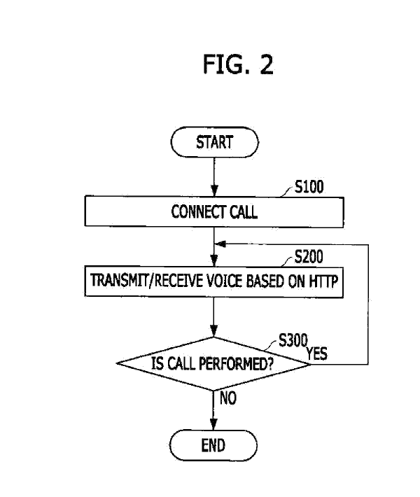

HTTP that can reduce a time and the cost which are expended in establishing a voice transmission system, can easily solve a transmission compatibility issue between networks and a firewall issue, and can transmit a highest-quality voice by reflecting a network state in a call operation. Hereinafter, exemplary embodiments of the present invention will be described in detail with reference to FIGS. 1 and 2.

FIG. 1 is a block diagram illustrating an adaptive voice communication system based on HTTP according to an embodiment of the present invention.

The adaptive voice communication system based on HTTP according to an embodiment of the present invention may include a web server 100, which issues a session identifier (ID), a talk transmission uniform resource locator (URL), and a talk reception URL and transmits an HTTP response in response to an HTTP request, and a web client 200 that transmits the HTTP request and transmits or receives voice information by using the issued talk transmission URL and talk reception URL.

Hereinafter, a message which is transmitted when the web client 200 requests a service from the web server 100 may be referred to as an HTTP request, and a response message transmitted from the web server to the web client 200 may be referred to as an HTTP response.

The web client 200 may access to a predetermined URL of the web server 100 by using an HTTP GET method, and thus, a call may start.

At this time, the web client 200 may be newly issued a session ID, a talk transmission URL for transmitting a talk, and a talk reception URL for receiving the talk from the web server 100.

The web client 200 and the web server 100 may maintain consistency and may perform a talk by using the session ID, and then, a talk may be performed by using two the newly issued URLs.

According to an embodiment of the present invention, the talk transmission URL may be a URL for transmitting a voice to the other party of the web client 200 and may be provided by using an HTTP POST method. Similarly to the multimedia streaming service, the talk reception URL may be a URL, which is in the web server 100, for receiving talk content of the other party and may be provided by using the HTTP GET method.

According to an embodiment of the present invention, the HTTP request and the HTTP response may each include information about whether to perform a call, in addition to session information based on a session ID. The web client 200 and the web server 100 may determine whether to maintain or end a talk connection (session maintenance).

In transmitting a voice of the web client 200, the web client 200 may transmit the voice by using a talk transmission URL which is initially issued when being initially connected to the web server 100.

As described above, in this case, the web client 200 may transmit voice information by using the HTTP POST method. Such an access may be made only when there is voice information which is to be transmitted by the web client 200.

An HTTP request message which is to be transmitted by the web client 200 and an HTTP response message which is to be transmitted by the web server 100 may each include a session ID and information about whether to perform a call, except an initial connection and may also include information about whether to continuously maintain the call.

When there is voice information which is to be transmitted, the web client 200 may transmit a voice decoding scheme and voice compression data along with a talk transmission URL.

In this case, the web client 200 may determine a voice sampling rate or a network transmission bit rate based on states of a network and the web client 200, sample and compress the voice information based on the voice sampling rate or the network transmission bit rate, and transmit the compressed voice information to the web server 100.

That is, the voice sampling rate or the network transmission bit rate may be determined by the web client 200.

In transmitting a voice, the web client 200 may repeat the above-described process. When desiring to terminate the call, the web client 200 may set, to close, the information (which is included in the HTTP request message) about whether to perform the call and may transmit the set information to the web server 100, thereby terminating the call.

In an operation where the web server 100 receives a voice, the web server 100 may be supplied with voice information from the web client 200 by using a talk transmission URL which is issued after an initial access.

The web client 200 may provide materials to the web server 100 by using the HTTP POST method. The web server 100 may receive the materials and may restore the voice information to play a sound in the web server 100 end.

The web server 100 may be supplied with the voice decoding scheme and the voice compression message from the web client 200 and may restore the voice compression message to play a sound to the other party in the web server 100 end.

When the information (which is included in the HTTP request message and is received from the web client 200) about whether to perform the call indicates the close, the web server 100 may terminate the call.

In an operation where the web server 100 transmits a voice, the web server may provide voice information to the web client 200 by using a talk reception URL which is issued after an initial call access.

In this case, the web server 100 may refer to the voice sampling rate and the network transmission bit rate provided from the web client 200, determine a voice sampling rate value and a network bit rate value, based on a current state of the web server 100, and sample and compress a voice of a current caller, based on the voice sampling rate value and the network bit rate value.

A voice of the other party may be separated into a voice message at a time when the voice is broken or in units of a certain time, and the voice message may be displayed by the web server 100 in order for the web client 200 to receive the voice message through a GET method. The web server 100 may inform, by using an HTTP response message, the web client 200 that the voice message is displayed.

That is, the HTTP response message may include a new URL value for receiving a voice decoding scheme and a voice compression message.

The web server 100 may repeat the voice transmission operation, and when desiring to terminate a call, the web server 100 may set, to close, information (which is included in the HTTP request message) about whether to perform the call and may terminate the call.

Moreover, when the information (which is included in the HTTP request message received from the web client 200) about whether to perform the call is the close, the web server 100 may terminate the call.

If the web server 100 abnormally terminates a call and thus the web client 200 cannot receive any response from the web server 100 for a predetermined time, the web client 200 may terminate the call. On the other hand, when the web client 200 does not access the web server 100 for the predetermined time, the web server 100 may terminate a corresponding call.

In an operation where the web client 200 receives a voice, the web client 200 may receive voice information through a talk reception URL which is issued when being initially connected to the web server 100. In this case, the web client 200 may receive the voice information by using the HTTP GET method.

Similarly to a multimedia streaming operation, in such an access, reconnection may be attempted just as soon as a received voice message ends.

Except for an initial connection, all HTTP request messages and response messages may include a session ID and information about whether to perform a call, and thus may indicate information about whether to continuously maintain the call.

The web client 200 may provide a voice sampling rate and a network transmission bit rate value of a voice message of the other party after an initial call is made, and the web server 100 may add an URL, including a voice decoding scheme and compressed voice data, into an HTTP voice message corresponding thereto and may transmit the URL to the web client.

The web client 200 may access a newly provided URL through a GET method by using the voice decoding scheme provided from the web server 100 to receive the voice data, and may play a sound.

The web client 200 may repeat the above-described process, and when a response message where information about whether to a call is set to close is received, the web client 200 may terminate the call.

FIG. 2 is a flowchart illustrating an adaptive voice communication method based on HTTP according to an embodiment of the present invention.

The adaptive voice communication method based on HTTP according to an embodiment of the present invention may include: an operation of issuing a session ID, a talk transmission URL, and a talk reception URL and starting a call connection; an operation of transmitting voice information through the talk transmission URL by using the HTTP POST method; an operation of receiving the voice information through the talk reception URL by using the HTTP GET method; and an operation of checking information about whether to perform the call.

In step S100, the web client 200 may access a predetermined URL of the web server 100 by using the HTTP GET method to start a call, and may be issued a session ID, a talk transmission URL, and a talk reception URL from the web server 100.

In step 200, the web client 200 may transmit a voice through the talk transmission URL which is issued when being initially connected to the web server 100. In this case, the web client 200 may transmit voice information by using the HTTP POST method.

In step S200, when there is voice information which is to be transmitted by the web client 200, the web client 200 may transmit a voice decoding scheme and voice compression data through the talk transmission URL and may a voice sampling rate or a network transmission bit rate, based on states of a network and the web client 200.

Except for an initial connection, all HTTP request messages which is to be transmitted by the web client 200 may include a session ID and information about whether to perform a call, and moreover may include information about whether to continuously maintain the call.

In step 300, in an operation where the web client 200 transmits a voice, when desiring to terminate the call, the web client 200 may set, to close, the information (which is included in the HTTP request message) about whether to perform the call and may transmit the set information to the web server 100, thereby terminating the call.

In step 200, in an operation where the web client 200 receives a voice, the web client 200 may receive voice information through the talk reception URL which is issued when being initially connected to the web server 100. In this, case, the web client 200 may receive the voice information by using the HTTP GET method.

Except for an initial connection, all HTTP request messages and response messages may include a session ID and information about whether to perform a call, and thus may indicate information about whether to continuously maintain the call.

The web client 200 may access a newly provided URL through the GET method by using the voice decoding scheme provided from the web server 100 to receive voice data, and may play a sound.

The web client 200 may repeat the above-described process, and when a response message where information about whether to a call is set to close is received in step 5300, the web client 200 may terminate the call.

As described above, the adaptive voice communication system and method based on HTTP according to the embodiments of the present invention can easily and simply support voice communication by using the HTTP that is a protocol of a popularized web server. Also, by providing an optimized adaptive voice transmission scheme within an allowable range of a network state in consideration of the network state, a time and the cost which are expended in establishing a voice communication system are reduced, and the quality of voice communication is enhanced.

The web technology based on HTTP can easily solve a security issue and a connection issue between networks such as a firewall unlike other conventional communication network. Also, according to the embodiments of the present invention, the voice communication system can be easily established and operated on a web server, and thus, the cost of establishing the voice communication system is largely reduced.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented, by other components or their equivalents. Accordingly, other implementations are within the scope of the following claims.

What is claimed is:

1. An adaptive voice communication system based on hypertext transport protocol (HTTP), the adaptive voice communication system comprising:
a web server configured to issue a session identifier (ID), a talk transmission uniform resource locator (URL), and a talk reception URL and transmit an HTTP response in response to an HTTP request; and
a web client configured to transmit the HTTP request and transmit or receive voice information by using the issued talk transmission URL and talk reception URL.

2. The adaptive voice communication system of claim 1, wherein the web client accesses to a predetermined URL of the web server by using an HTTP GET method.

3. The adaptive voice communication system of claim 1, wherein
the talk reception URL for receiving talk content of other party is provided by using an HTTP GET method, and
the talk transmission URL for transmitting a voice to the other party is provided by using an HTTP POST method.

4. The adaptive voice communication system of claim 1, wherein when there is voice information which is to be transmitted, the web client determines a voice sampling rate or a network transmission bit rate based on states of a network and the web client, sample and compress the voice information, and transmit the compressed voice information to the web server.

5. The adaptive voice communication system of claim 4, wherein the web client provides materials to the web server by using an HTTP POST method, and the web server restores the voice information, based on the provided materials, to play a sound.

6. The adaptive voice communication system of claim 4, wherein in terminating a call,
the web client sets, to close, information about whether to perform the call and transmits the set information to the web server, the information being included in the HTTP request message, and
the web server receives the transmitted information to terminate the call.

7. The adaptive voice communication system of claim 1, wherein the web client receives voice information by using an HTTP GET method and attempts a reconnection as soon as the received voice information ends.

8. The adaptive voice communication system of claim 7, wherein the web server determines a voice sampling rate value and a network transmission bit rate value, based on a voice sampling rate and a network transmission bit rate provided from the web client and a state of the web server, and samples, compresses, and displays a voice.

9. The adaptive voice communication system of claim 8, wherein in terminating a call,
the web client sets, to close, information about whether to perform the call and transmits the set information to the web server, the information being included in the HTTP request message, and
the web server receives the transmitted information to terminate the call.

10. An adaptive voice communication method based on hypertext transport protocol (HTTP), the adaptive voice communication method comprising:
(a) issuing a session identifier (ID), a talk transmission uniform resource locator (URL), and a talk reception URL and starting a call connection;
(b) transmitting voice information through the talk transmission URL by using an HTTP POST method;
(c) receiving the voice information through the talk reception URL by using an HTTP GET method; and
checking information about whether to perform the call.

11. The adaptive voice communication method of claim 10, wherein step (a) comprises accessing a predetermined URL of a web server by using a GET method.

12. The adaptive voice communication method of claim 10, wherein step (b) comprises, when there is voice information which is to be transmitted by a web client, determining a voice sampling rate or a network transmission bit rate, based on states of a network and the web client and sampling, compressing, and transmitting the voice information, based on the voice sampling rate or the network transmission bit rate.

13. The adaptive voice communication method of claim 12, wherein step (b) comprises removing unnecessary noise and background sound before compressing the voice information.

14. The adaptive voice communication method of claim 10, wherein step (c) comprises, when a received voice message ends, immediately attempting a reconnection.

15. The adaptive voice communication method of claim 14, wherein step (c) comprises receiving a voice decoding scheme and compressed voice data included in an HTTP response and accessing the talk reception URL through a GET method to receive the voice information.

16. The adaptive voice communication method of claim 10, wherein step (d) comprises setting, to close, information about whether to perform a call, adding the set information into an HTTP request, and transmitting the HTTP request to terminate the call, or when information, included in an HTTP response, about whether to perform a call is set to close, terminating the call.
